(19) United States
(12) Patent Application Publication
(10) Pub. No.: US 2018/0173385 A1
(43) Pub. Date: Jun. 21, 2018

(54) System and Method for Incremental Diagram Node Expansion

(71) Applicant: Siemens Product Lifecycle Management Software Inc., Plano, TX (US)

(72) Inventors: Heng Zhang, XiAn City (CN); Shingchi Hsu, Cypress, CA (US)

(21) Appl. No.: 15/386,043

(22) Filed: Dec. 21, 2016

(51) Int. Cl. G06F 3/0484; G06F 3/0482; G06T 11/20

(52) U.S. Cl. CPC G06F 3/0484; G06T 2200/24; G06T 11/206; G06F 3/0482

(57) ABSTRACT

A system and method is provided for incremental diagram node expansion in which a table-like layout is used to place nodes. The system may include a processor configured to display a diagram through a display device that includes a pre-existing first selected node. Responsive to a first input, the processor may carry out a first incremental expansion process to add at least one outgoing level of nodes to the diagram with respect to a first selected node. The at least one outgoing level includes additional nodes that are outgoing nodes corresponding to data objects that are children and optionally grandchildren of the data object corresponding to the first selected node based on parent-child relationships stored in a data store. Responsive to a subsequent second input the processor may carry out a second incremental expansion process to add at least one incoming level of nodes to the diagram with respect to the first selected node. The at least one incoming level includes additional nodes that are incoming nodes corresponding to data objects that are parents or optionally grandparents of the data object corresponding to the first selected node based on the parent-child relationships. The system may also permit the second incremental expansion process to take place before the first incremental expansion process.

### TECHNICAL FIELD

The present disclosure is directed, in general, to computer-aided design (CAD), computer-aided manufacturing (CAM), computer-aided engineering (CAE), visualization, simulation, and manufacturing systems, product data management (PDM) systems, product lifecycle management (PLM) systems, and similar systems, that are used to create, use, and manage data for products and other items (collectively referred to herein as product systems).

### BACKGROUND

Product systems may be used to search, organize and display product data stored in databases. Such systems may benefit from improvements.

### SUMMARY

Variously disclosed embodiments include data processing systems and methods that may be used to facilitate incremental diagram node expansion. In one example, a system may comprise at least one processor configured to display a diagram through a display device that includes a pre-existing first selected node that respectively corresponds to a data object related via parent-child relationships to other data objects stored in a data store. In addition, the processor may be configured to be responsive to a first input through an input device, to carry out a first incremental expansion process to add at least one outgoing level of nodes to the diagram with respect to a first selected node. The at least one outgoing level may include additional nodes that are outgoing nodes corresponding to data objects that are children and optionally grandchildren of the data object corresponding to the first selected node based on the parent-child relationships. In addition, the at least one processor may be configured to be responsive to a subsequent second input through the input device, to carry out a second incremental expansion process to add to the diagram at least one incoming level of nodes with respect to the first selected node, wherein the at least one incoming level includes additional nodes that are incoming nodes corresponding to data objects that are parents or optionally grandparents of the data object corresponding to the first selected node based on the parent-child relationships.

In another example, a method for incremental diagram node expansion may comprise several acts carried out through operation of at least one processor. These acts may include displaying a diagram through a display device that includes a pre-existing first selected node that respectively corresponds to a data object related via parent-child relationships to other data objects stored in a data store. The acts may also include responsive to a first input through an input device, carrying out a first incremental expansion process to add to the diagram at least one outgoing level of nodes with respect to a first selected node, wherein the at least one outgoing level includes additional nodes that are outgoing nodes corresponding to data objects that are children and optionally grandchildren of the data object corresponding to the first selected node based on the parent-child relationships. In addition, the acts may include responsive to a subsequent second input through the input device, carrying out a second incremental expansion process to add to the diagram at least one incoming level of nodes with respect to the first selected node, wherein the at least one incoming level includes additional nodes that are incoming nodes corresponding to data objects that are parents or optionally grandparents of the data object corresponding to the first selected node based on the parent-child relationships.

A further example may include a non-transitory computer readable medium encoded with executable instructions (such as a software component on a storage device) that when executed, causes at least one processor to carry out this described method.

Another example may include a product or apparatus including at least one hardware, software, and/or firmware based processor, computer, component, controller, means, module, and/or unit configured for carrying out functionality corresponding to this described method.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 illustrates a functional block diagram of an example system that facilitates incremental diagram node expansion.

FIG. 2 illustrates an example of node expansion in which pre-existing nodes are moved to accommodate new additional nodes.

FIG. 3 illustrates an example of node expansion in which pre-existing nodes are not moved to accommodate new additional nodes.

FIG. 4 illustrates an example of a non-displayed grid that may be used to align and space-apart nodes added to a diagram.

FIG. 5 illustrates an example of incrementally adding one additional outgoing level of outgoing nodes to a diagram with respect to a selected node.

FIG. 6 illustrates an example of incrementally adding two additional outgoing levels of outgoing nodes to a diagram with respect to a selected node.

FIG. 7 illustrates an example of a re-layout of a diagram.

FIG. 8 illustrates an example of a reverse expansion of a diagram.

FIGS. 9-10 illustrate steps for an incremental expansion of nodes that include circular relationships and a re-layout of the diagram with such relationships.

FIG. 11 illustrates a flow diagram of an example methodology that facilitates incremental diagram node expansion.

FIG. 12 illustrates a block diagram of a data processing system in which an embodiment may be implemented.

### DETAILED DESCRIPTION

Various technologies that pertain to systems and methods that facilitate incremental diagram node expansion will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

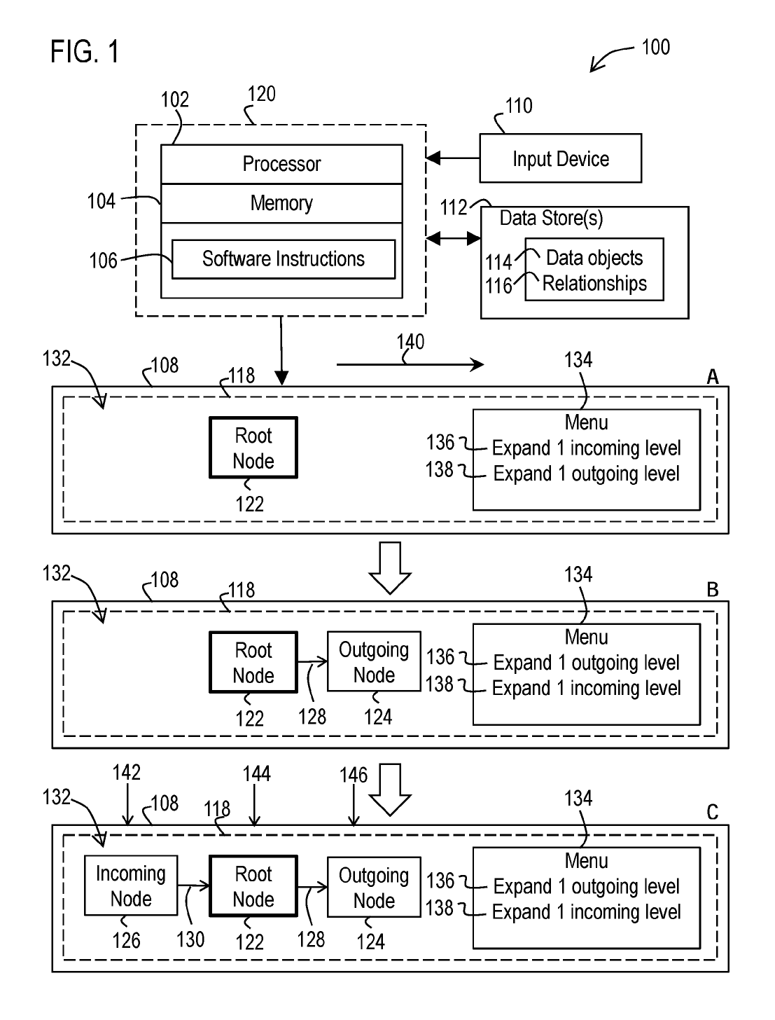

With reference to FIG. 1, an example data processing system 100 is illustrated that facilitates incremental diagram node expansion. The system 100 may include at least one processor 102 (e.g., a microprocessor or CPU) that is configured to carry out various processes and functions described herein via software instructions 106 (included in at least one application software component) that are accessed by the processor from a memory 104 and executed by the processor. Such a memory 104 may correspond to an internal or external volatile memory (e.g., main memory, CPU cache, and/or RAM), that is included in the processor and/or in operative connection with the processor. Such a memory 104 may also correspond to a nonvolatile memory (e.g., flash memory, SSD, hard drive, or other storage device or non-transitory computer readable media) in operative connection with the processor.

It should be understood that a processor that is described or claimed as being configured to carry out a particular described/claimed processes or function may correspond to the combination 120 of the processor 102 with the software instructions 106 loaded/installed into the described memory 104 (volatile and/or non-volatile), which are currently being executed and/or are available to be executed by the processor to cause the processor to carry out the described/claimed process or function. Thus a processor that is powered off or is executing other software, but has the described software instructions installed on a storage device in operative connection therewith (such as a hard drive or SSD) in a manner that is setup to be executed by the processor (when started by a user, hardware and/or other software) may also correspond to the described/claimed processor that is configured to carry out the particular processes and functions described/claimed herein. Further, it should be understood that a processor that is described or claimed as being configured to carry out a particular described/claimed process or function may correspond to a microprocessor that is hard wired (e.g., an FPGA or ASIC microprocessor) to carry out such a described/claimed process or function.

The described data processing system 100 may include at least one display device 108 and at least one input device 110 in operative connection with the processor. The display device, for example, may include an LCD display screen, monitor, and/or a projector. The input devices, for example, may include a mouse, pointer, touch screen, touch pad, drawing tablet, track ball, buttons, keypad, keyboard, camera, motion sensing device that captures motion gestures, and/or any other type of input device capable of providing the inputs described herein. For example, the processor 102, memory 104, software instructions 106, display device 108, and input device 110, may be included as part of a data processing system corresponding to a PC, workstation, server, notebook computer, tablet, mobile phone, or any other type of computing system, or any combination thereof.

In an example embodiment, the described software instructions 106 may include and/or correspond to one or more components of a PLM software application that is configured to retrieve, generate, and store product data in a data store 112 such as a database (e.g., Oracle, Microsoft SQL Server), file system, hard drive, SSD, memory card and/or any other type of device or system that stores non-volatile data.

Example embodiments may include software instructions 106 that carry out a diagramming algorithm included by or used with PLM software or any other type of software that accesses and/or manages data objects that can be organized and displayed via a diagram that illustrates relationships between data objects. Examples of PLM software applications that may be adapted to carry out the features and functions described herein may include the NX suite of applications, Solid Edge software, and/or Teamcenter software, produced by Siemens Product Lifecycle Management Software Inc., of Plano, Tex., US. However, it should be appreciated that the systems and methods described herein may be used in other product systems that manage product data or other types of data objects.

As illustrated in FIG. 1, the at least one processor 102 may be configured (via the software instructions 106) to access data objects 114 (e.g., data files, data records, or any other type of stored information) from the data store 112 and generate therefrom diagrams 118 in a user interface 132 displayed through the display device 108. Such diagrams may depict information associated with the data objects as well as relationships 116 between the data objects. For example, such data objects may corresponds data records including information regarding product data such as parts, components, assemblies, machines, revisions, functions, requirements, Bill of Material (BOM) lines, lifecycle data, CAD drawings, test results, system models, metadata, and/or any other information that is associated with products.

The data objects may include or may be associated with data stored in the data store representative of relationships (i.e., associations) between the data objects. Such data object relationships may specify parent-child relationships (one-to-one or one-to-many relationships) as well as recursive relationships. An example of a parent-child relationship may correspond to a data object for an assembly (i.e., the parent component) that is made up a plurality of smaller parts (i.e., child components). Such, child components may further correspond to an assembly comprises of smaller child components. Furthermore, each component may be associated with one or more different revisions (i.e., variations on how the part is constructed). In another example, data objects for requirements or functions (for a product) may be specify (e.g., be associated with) other data objects for requirements via child-parent relationships. Such data objects and associated parent-child relationships may form a hierarchical arrangement in which parent objects are at a first level, children objects are at a second level, grandchildren objects are at a third level, and other objects may be at other levels (e.g., higher or lower in the hierarchy).

Such data objects and the relationships therebetween may be displayed through the display screen 108 in the form of a diagram 118 (e.g., a chart) in which nodes 122, 124, 126 (e.g., labeled boxes, circles or other shapes) represent data objects and in which connectors 128, 130 (lines, links, arrows, or other graphics depicting connections between the data objects) represent the relationships.

However, it should also be appreciated that complex products may be represented by many data objects and relationships (e.g., hundreds, thousands, or millions of data objects for a complex machine). Displaying a hierarchical diagram with hundreds or thousands of data objects on a workspace (even if scrolling is available) may be difficult for a user to analyze and understand.

To enhance the visualization and comprehension of such hierarchical data by a user, an example embodiment may use the processor 102 (configured via software instructions 106) to generate the user interface 132 through the display screen 108 to enable a user to incrementally explore (via user provided inputs) the stored data and relationships by incrementally displaying portions of the organization of such hierarchical stored data objects in the data store 112.

Thus, a user may progressively select different desired nodes and issue commands to the user interface to show in the diagram one or more additional levels of nodes for related data objects, without having to display the entire hierarchical arrangement of data objects stored in the data store.

FIG. 1 depicts three views (A, B and C) of the user interface 132. In view A, the diagram 118 includes an initial root node 122 that may correspond to the first node added to the diagram by the user via the user interface (e.g., determined via a search). Such a root node 122 may be selected (as visually indicated by the relatively bolder lines used to draw the root node). The user interface may provide a menu 134 (or keyboard commands, buttons or other user interface selections) that enable a user to provide a command to incrementally expand the number of nodes displayed by the diagram in order to show at least some additional nodes that are related to the particularly selected node in the diagram.

For example, the user may select the menu option 136 of the menu 134 in order to expand one outgoing level of nodes (e.g., for child nodes) for the selected root node 122 via inputs through the input device 110. In response to such a selection, the processor may be configured to carry out an incremental expansion process which generates and displays (in view B) at least one additional node (e.g., the outgoing node 124) for at least one additional data object in the diagram 118 that is related via at least one outgoing parent-child relationship 116,128 stored in a data store 112 to the selected pre-existing data object displayed via the pre-existing node (e.g., the root node 122) in the diagram 118 through the display device 108.

Subsequently for example, the user may select the menu option 138 of the menu 134 in order to expand one incoming level of nodes (e.g., for parent nodes) for the selected root node 122 via inputs through the input device 110. In response to such a selection, the processor may be configured to carry out the incremental expansion process which generates and displays (in view C) at least one additional node (e.g., the incoming node 126) for at least one additional data object in the diagram 118 that is related via at least one incoming parent-child relationship 116, 130 stored in a data store 112 to the selected pre-existing data object displayed via the pre-existing node (e.g., the root node 122) in the diagram 118 through the display device 108.

In this example of a diagram, the direction of the arrow on the connector 128 (from the root node 122 to the outgoing node 124) indicates that the outgoing node 124 is a child node with respect to root node 122 (i.e., a lower level node in the hierarchical relationship between them) and that the root node is a parent node with respect to the outgoing node (a higher level node in the hierarchical relationship between them). Similarly the direction of the arrow on the connector 130 (from the incoming node 126 to the root node 122) indicates that the incoming node 126 is a parent node with respect to the root node 122 (i.e., a higher level node in the hierarchical relationship between them) and that the root node is a child node with respect to the incoming node (a lower level node in the hierarchical relationship between them).

It should be appreciated that in this example, the user is enabled to expand nodes in one hierarchical direction 140 (e.g., to add lower level children or grandchildren outgoing nodes) with respect to a selected node and subsequently expand nodes in an opposite hierarchical direction (e.g., to add higher level parent or grandparent incoming nodes) with respect to the same selected node, or different selected node, or vice-a-versa. Also, it should be appreciated that the user may expand additional levels of nodes, and/or more than one additional level of node. For example the menu 134 may include options to expand 2, 3, all, or other number of levels of outgoing and/or incoming levels of nodes relative to a selected node.

Further it should be noted that different levels of nodes and the root node may be placed in different columns 142, 144, 146 (or rows). Further, as will be explained in more detail below, it should be appreciated that in example embodiments, each subsequently carried out incremental expansion process adds additional nodes to the diagram in a manner that may not change the previously alignment of nodes in different columns generated during previously incremental expansion processes.

In addition, the user interface may also include menu options, buttons or other user interface controls, which enable the user to select the style of the diagram that specifies the type of shapes and formatting of the nodes and connectors. Such a style may also indicate the hierarchical direction of the diagram with respect to: from higher levels to lower levels. For example, FIG. 1 illustrates a style of nodes in which such a hierarchical direction 140 proceeds from left to right (horizontally) from incoming parents to outgoing children nodes. However, it should be appreciated that other selected styles of diagrams may order levels from right to left (horizontally), top to bottom (vertically), in diagonal directions, in circular directions, or any other pattern or order.

As used herein, the alignment of nodes or levels of nodes may be described as being in a particular columns or rows. However, it should be understood that the wording of columns and rows should be construed broadly as corresponding to aligned sets of nodes (or other objects) having a perpendicular arrangement with respect to each other regardless of whether which of the columns or rows are vertically arranged, horizontally arranged, or arranged along another direction. Thus a grid of nodes may have columns that are vertically arranged and rows that are horizontally arranged. However, in another embodiment, columns of nodes may be horizontally arranged and rows of nodes may be vertically arranged. As used herein, a described/claimed row of nodes is perpendicular to a described/claimed column of nodes in the same grid arrangement, but does not specify which of the rows or columns are orientated vertically or horizontally or diagonally with respect to the orientation of a display screen and the direction of gravity.

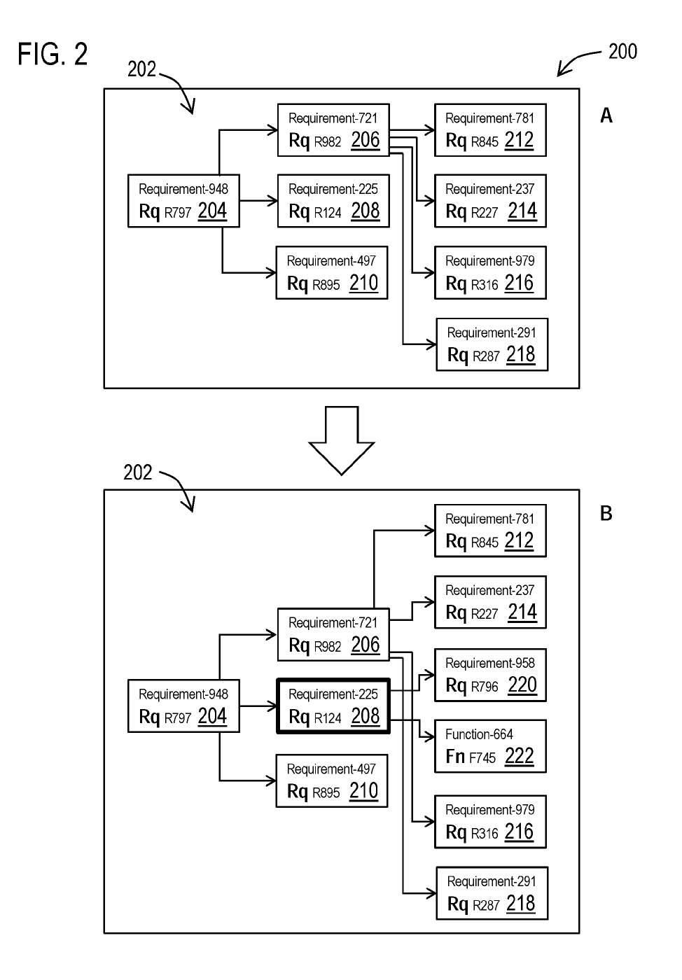

In example embodiments, that expansion of one or more incoming or outgoing levels may result in several nodes being added to the diagram. For example, FIG. 2 illustrates an example 200 in view A of the diagram 202 where there are three child nodes or outgoing nodes 206-210 with respect to the root node 204 and there are four grandchild nodes 212-218 (which are children or outgoing nodes of child node 206).

To incrementally display additional nodes, the user for example may select the child node 208 and provide a command input to expand one additional level of outgoing nodes with respect to the selected child node 208. In response to this input, the processor may be configured to update the diagram 202 as illustrated in view B of FIG. 2 to display the additional nodes 220, 222 which are children of child node 208. In this example, the software instructions which generate the diagram have placed the new additional nodes 220, 222 in the middle of the grandchildren nodes 212-222 and has arranged the nodes to be symmetrically aligned and spaced in a vertical direction with respect to the root node 204.

Although such a symmetrically alignment and spacing of the diagram in view B enhances the cosmetic appearance of the diagram, the moving and re-ordering of the original grandchildren nodes 212-218 may confuse the user. For example, in view B of FIG. 2, the diagramming algorithm has pushed preexisting nodes into new positions to avoid overlapping nodes. Such rearrangement via the pushing/moving of nodes may produce chain reaction positioning that results in unpredictable outcomes. Also, in view B, the diagramming algorithm has produced a different alignment result (between pre-existing nodes in different columns) than prior to the update, which changes the order of some nodes with respect to each other.

Thus, an example embodiment may be configured to minimize confusing the user as illustrated in view B, by providing enhanced predictability as to how the diagram will change in response to commands to incrementally expand the number of nodes in the diagram.

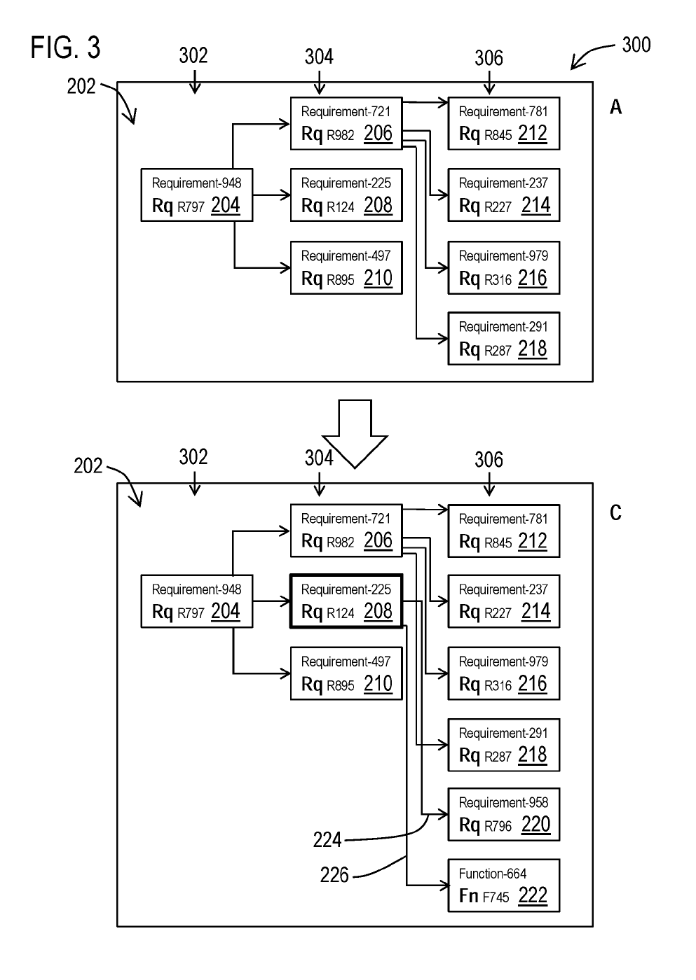

For example, referring to example 300 of FIG. 3, (using a diagramming algorithm of an example embodiment) the same selection made in view A of FIG. 3 (which corresponds to view A in FIG. 2) with respect to displaying children of node 208, produces a different arrangement in view C of FIG. 3 compared to the arrangement in view B in FIG. 2. In this example, the original arrangement of nodes in view A remains the same in view C of FIG. 3 (whereas this was not the case in view B of FIG. 2). Rather, in view C of FIG. 3, the additional nodes 220, 222, which are children of node 208, are arranged in the same level as grandchildren nodes 212-218, but are positioned below them (rather than in the middle of them as shown in view B of FIG. 2). By incrementally adding the additional nodes 220, 222 in a predictable location, but without changing the original spatial arrangement of nodes 204-218, the user may be able to learn and comprehend the relationships between data objects faster. This manner of an incremental expanding of the nodes in the diagram avoids the user having to spend time reinterpreting parts of the diagram that were previously understood by the user.

This described process of displaying additional nodes without moving existing nodes may be typically apparent after at least one incremental expansion process has been carried out to cause a plurality of pre-existing nodes 204-218 to be displayed in the diagram in a plurality of different columns 302, 304, 306 corresponding to different hierarchical levels based on the parent-child relationships, with at least one column including more than one pre-existing node.

To carry out this example, the processor 102 may be configured via software instructions 106 to be responsive to a further input through the input device, to carry out a further incremental expansion process with respect to a selected further node 208. For the further incremental expansion, the processor may be configured to determine at least one additional data object that is related via at least one parent-child relationship stored in the data store to the data object for the selected further node 208. Also the processor may determine a column 306 for the diagram to add at least one additional node 220, 222. Such a determined column 306 may include a plurality of pre-existing nodes 212-218 that have the same level of parent/child relationships with their respective parents. In this example, the at least one additional node 220, 222 may correspond to the at least one additional data object based on the at least one parent-child relationship between the at least one additional data object and the data object for the selected further node 208. In addition the processor may determine a position in the determined column 306 to display the at least one additional node 220, 222 such that the positions of all additional nodes added to the determined column 306 are located adjacent (e.g., next to) all pre-existing nodes in the determined column 306 and not between pre-existing nodes in the determined column 306 and such that an alignment between the pre-existing nodes in different columns remains unchanged. Further the processor may cause the at least one additional node 220, 222 to be displayed in the diagram through the display device at the determined position in the determined column, such that the alignment between the pre-existing nodes in different columns remains unchanged (e.g., see view C of FIG. 3).

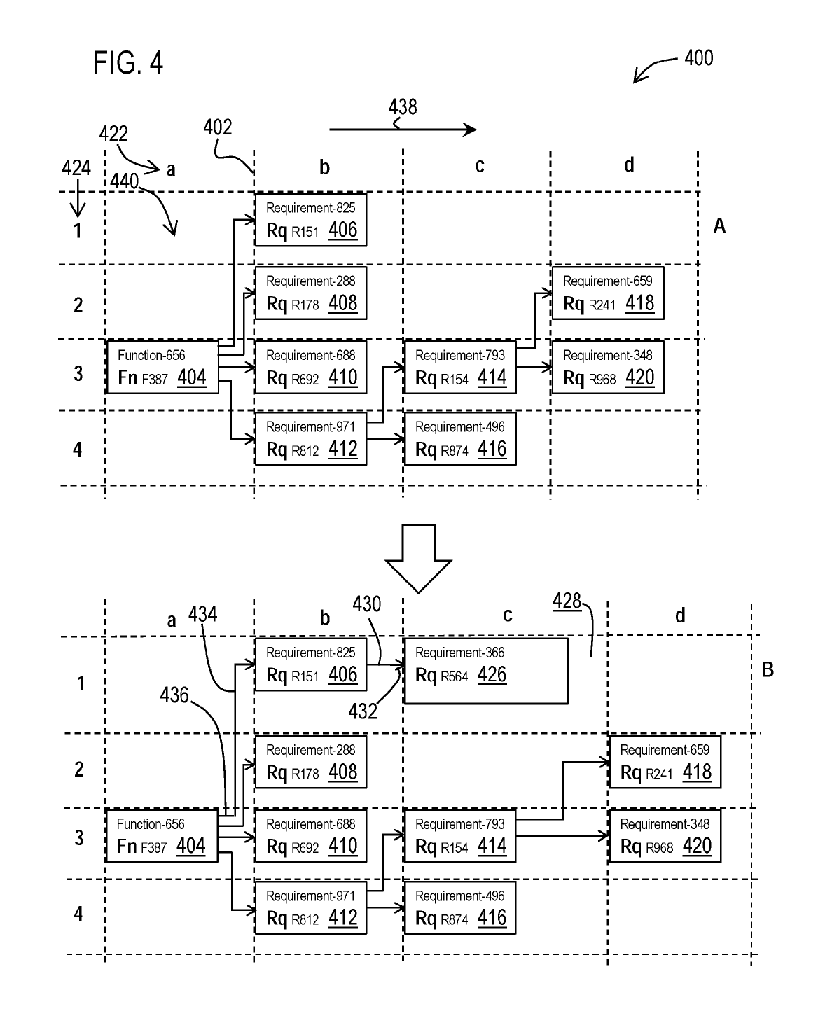

In order to achieve the arrangement of nodes described herein with an incremental update to the diagram, the processor may be configured to determine the locations of nodes based on a non-displayed grid (i.e., a table structure) of rows and columns. FIG. 4 illustrates an example 400 of such a grid 402. It should be appreciated that in the described example embodiments, the layout of the grid is maintained in the memory of the processor and is not displayed in the diagram. However, in alternative examples, the grid may be displayed with the diagram.

As illustrated in view A of FIG. 4, in this example, the processor may be configured (e.g., via the software instructions) to allocate each of a plurality of pre-existing nodes 404-420 to individual cells 440 of a two dimensional grid 402 in which the cells are arrange in a plurality of columns 422 and rows 424. In this example, each cell has a width and a height based on a respective width and a respective of height of the respective column and respective row of each respective cell. Also, a column's width may be based on the widest node found in that column plus some additional padding (i.e., space) for the display of connectors. Similarly, the row's height may be based on tallest node found in that row plus some additional padding (i.e., space) for the display of connectors. The processor may relatively position the nodes 404-420 in the diagram based on the relative positions of the cells in the grid.

In these examples, when additional nodes are added to cells, the relative positions of pre-existing node positions in cells relative to pre-existing nodes in other cells may be left unchanged in order to avoid unpredictable behavior. Thus, if one pre-existing node in an adjacent column and in the same row as another pre-existing node, then such relative positions will be maintained when a new node is added.

For example, as illustrated in view B of FIG. 4, when additional node 426 is added, the processor may place such an additional node in a cell 428 that does not include a pre-existing node. Also, as illustrated in view B of FIG. 4, some nodes may be larger than other nodes. When such larger nodes are added to the cells, the respective columns and/or rows to which they are added may be adjusted to accommodate the size of the additional nodes. Such adjustment to the columns and/or rows may cause pre-existing nodes in the adjusted columns and/or rows to move, but the relative alignment between preexisting nodes in cells remains the same.

Also, as illustrated in FIG. 4, nodes may be aligned to one or more edges of the cells (such as the top-left edges of the cells), which alignment may be specified by the selected style of the diagram and/or may be independently selected via a menu option in the user interface. For example, the processor may enable the user to centrally align (vertically and/or horizontally) the nodes with respect to the cell in which they are contained.

To carry out these described features and functions, the software instructions for the described diagramming algorithm may configure the processor to maintain several rules for the grid, such as: 1) one cell can only contain one node; the cell size is equal to the sum of the node's size in addition to a predetermined node-to-node distance (which may be configurable and/or set via the described diagram style); 3) the row (or column) size is determined by the size of the nodes in the row (or column); 4) the width of a column is defined from the node in the column with the largest width among all the nodes in that specific column; 5) The height of a row is defined from the tallest node among all the nodes in that specific row; 6) if a larger node is added into a row (or column), the respective row (or column) will then enlarge appropriately; and/or 7) all nodes in the table use the same alignment option (e.g., align to the top-left corner of the cell).

In these examples, outgoing nodes 426 may have a connector 430 “entering” it, which may be visually represented by an arrowhead 432 on the connector. Also, incoming nodes 404 may have a have a connector 434 “exiting” it, which may be visually represented by a straight line 436 where the connector attaches to the node.

Also, the previously, described levels of nodes may correspond to a column 424 of the grid 402 of nodes along the hierarchical direction 438 from incoming to outgoing nodes (e.g., a left-to-right hierarchical direction 438 will mean a level corresponds to each column). As defined herein, a head node 406 in the diagram corresponds to the first node in the level and is dependent on the hierarchical direction (e.g., Left-to-Right will have the head node as the top-most node in the level, such as shown in column b). In addition, a tail node 412 in the diagram corresponds to the last node in the level and is dependent on the hierarchical direction (e.g., left-to-right will have the tail node as the bottom-most node in the level, such as shown in column b). In addition. Further, a seed node in the diagram corresponds to the initial node (such as the root node 122) with which all new nodes have a relationship during the incremental expansion process by which nodes are added to the diagram.

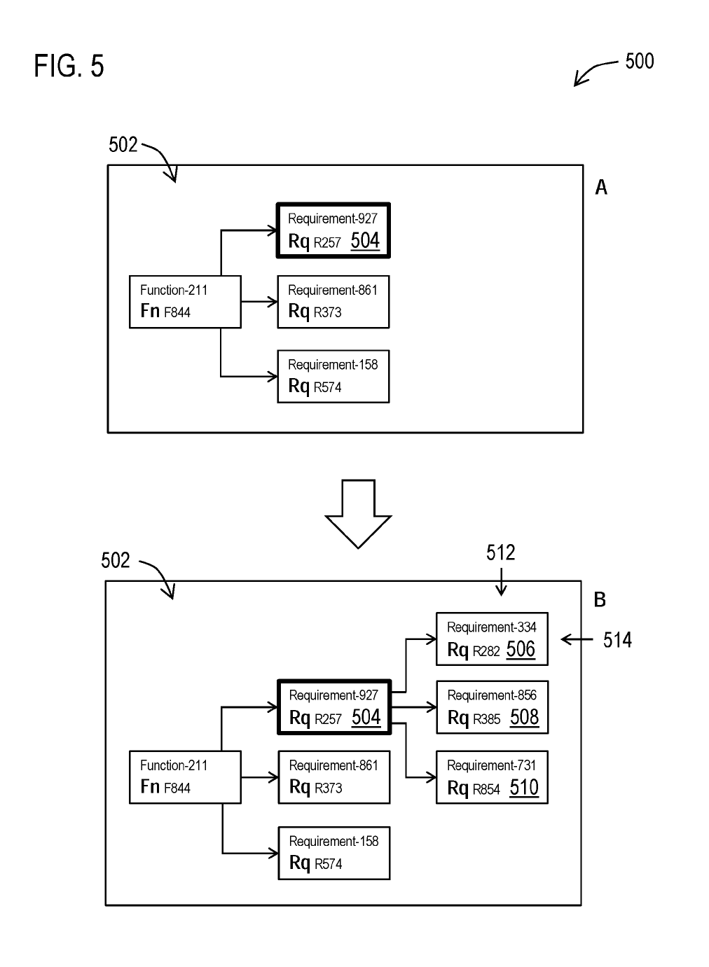

FIG. 5 illustrates an example 500 of a diagram 502 from view A to view B, in which a user has selected the incremental expansion process (e.g., via a user menu) to add one additional level 512 (e.g., column) of outgoing nodes 506-510 with respect to a selected pre-existing node 504 in the diagram. In this example, the processor may be configured to determine the position in the new column 512 to display the additional nodes 506-510 such that the position of at least one of the additional nodes 508 added to the column 512 (that does not include pre-existing nodes) is located in a cell that is adjacent a cell that includes at least one pre-existing node 504 (e.g., in a common row 514).

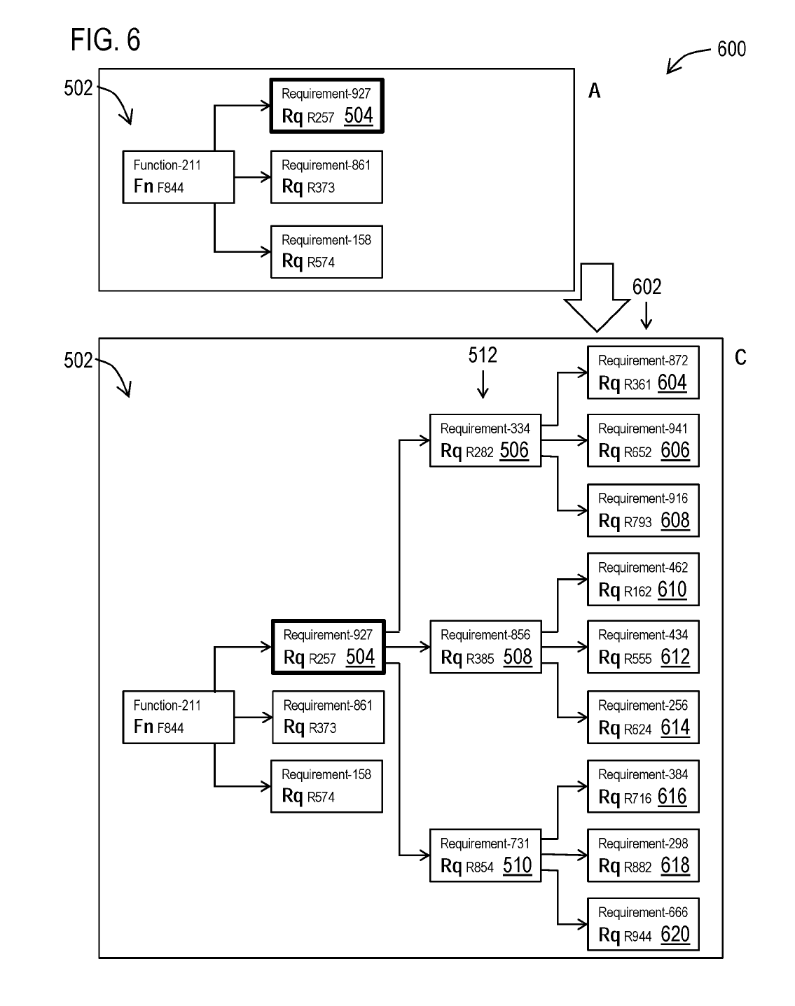

FIG. 6 illustrates an example 600 of the diagram 502 from view A to view C, in which a user has alternatively selected the incremental expansion process (e.g., via a user menu) to add two additional levels 512, 602 (e.g., columns) of outgoing nodes 506-510, 604-620 with respect to the same selected pre-existing node 504 in the diagram. Here, the spacing for nodes in column 512 is based on the furthest spaced apart children in the incremental expansion (e.g., in column 602 in this example) to achieve symmetrical distribution (i.e., balancing) when there is room available in the diagram (e.g., no other pre-existing noes in the expansions area of the diagram).

FIGS. 5 and 6 illustrate examples where the additional nodes are added to new levels (e.g., columns) that did not previously include pre-existing nodes. As discussed previously with respect to FIG. 3, when additional nodes have relationships that place them in levels (e.g., columns that include pre-existing nodes, such additional nodes are added to unoccupied cells in the grid either adjacent the head node 212 or adjacent the tail node 222, depending on which of the head node or tail node is closest to the seed node (e.g., the root node 204).

It should be appreciated that by carrying out the described incremental expansion process several times individually, the overall layout of the diagram may be more asymmetrical than if the entire diagram where expanded all at once. Thus, an example embodiment of the processor may enable the user to re-layout the diagram (if desired) after several incremental expansion process steps.

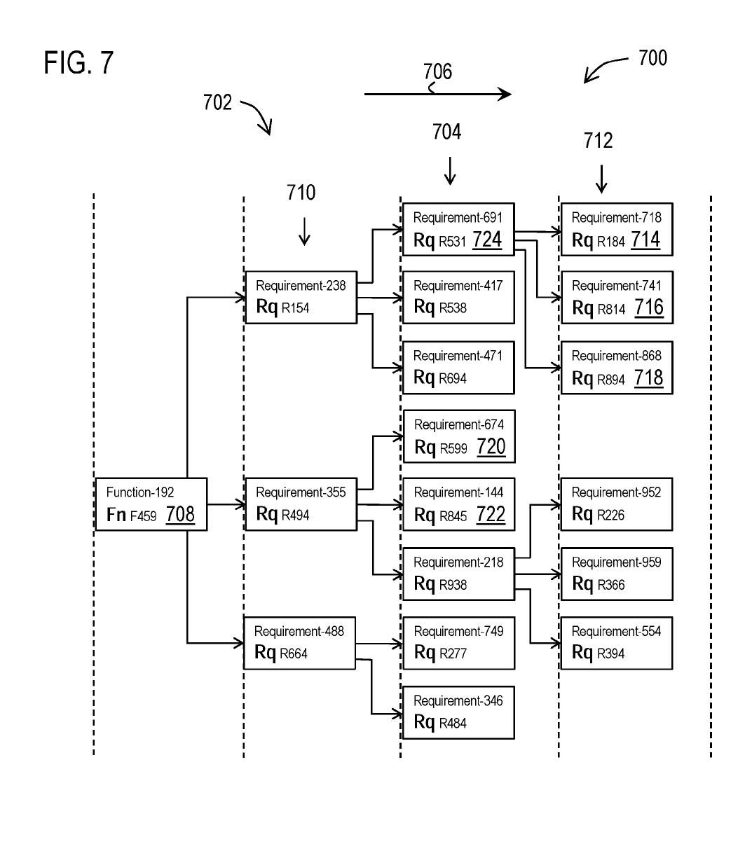

FIG. 7 illustrates an example 700 of a diagram 702 that has undergone such a re-layout, wherein the diagram includes only outgoing (or only incoming expansions). This re-layout of the diagram may allocate all nodes positons to visually balance the diagram in a manner that is relatively more symmetrical and compact. In this example, the software instructions for the example diagraming algorithm may configure the processor to carry out several steps for the grid, such as: 1) use the level (e.g., column) 704 with the largest number of nodes as the origin level for re-positioning all other nodes/levels; 2) the largest level will have its nodes re-group so that they are closer together; 3) The nodes in the largest level will then be move perpendicularly to the hierarchical direction 706 so that a central node 720 or 722 in the column 704 is aligned with the root node 708; 4) all other levels 710 between the root node 708 and the largest level 704 will have its node's positions re-organized in the level to align about the middle of the downstream level (the next level based on the hierarchical direction 706); 5) all other levels 712 after the largest level 704 may be expanded from the head to tail of its level, while keeping the level's length to be equal or less than the largest level 704.

In FIG. 7, the nodes in the level 712 were allocated based on the largest level 704. In the original version of this diagram (before re-layout) some of the first three nodes 714-718 in Level 712 may have extended above the head node 724 in level 704. Thus, in this example re-layout of the diagram, nodes 714-718 in level 714 may have been shifted perpendicularly to the hierarchical direction 706 (e.g., downwardly) to avoid exceeding the boundary of the level 704 and extending beyond the head node 724.

To carry out a re-layout, the processor 102 may be configured to receive through the at least one input device 110, a further input corresponding to a request to re-layout the diagram (e.g., via a user interface menu selection). In response to the further input, the processor may automatically carry out a balancing process on the existing nodes in the diagram. As described previously, for this balancing process, the at least one processor may be configured to determine a largest column with the largest number of nodes relative to the number of nodes in at least one other column in the diagram. Also the processor may be configured to position the nodes in the determined largest column in cells such that there are no unfilled cells between the nodes in the largest column and at least one central node in the largest column is aligned with a root node in a further column. For an odd number of nodes in the largest column, the central node may correspond to the middle node in the set. However, for an even number of nodes in the largest column, the central node may correspond to one of the pair of middle nodes in the set (such as the upper or lower one of the middle nodes). In addition, to re-layout the diagram the processor may be configured to position all nodes in the at least one other column in cells so as to be aligned with nodes in the largest column.

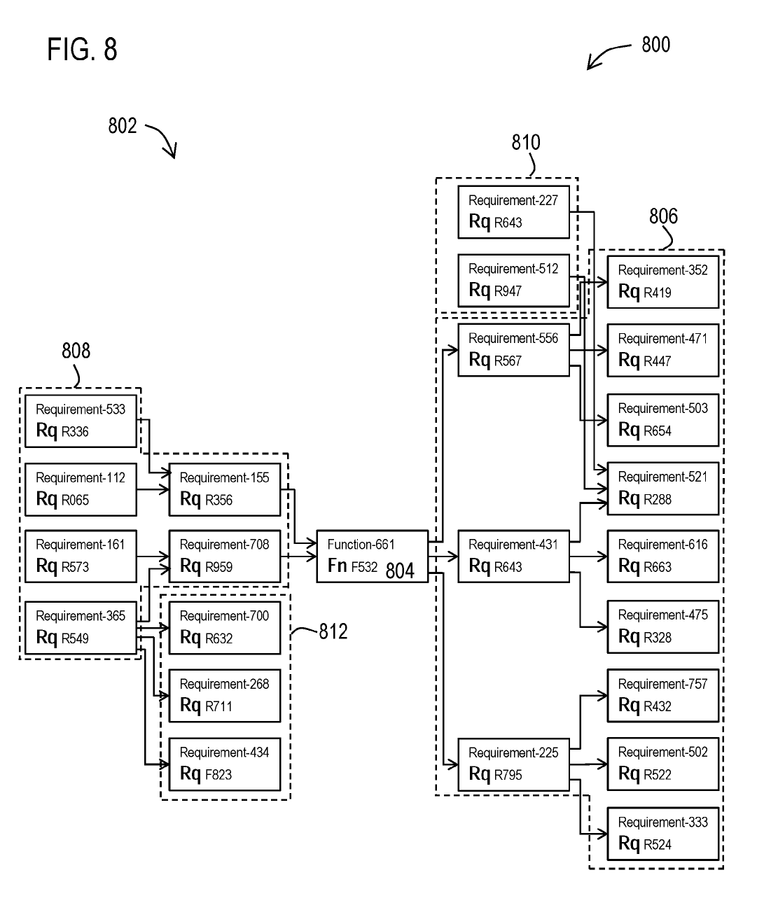

FIG. 8 illustrates another example 800 of a re-layout that was carried out on a diagram 802 that was generated via several incremental expansion processes to add a plurality of sets 806, 808, 810, 812 of both incoming and outgoing nodes. To produce the lay-out shown in FIG. 8 in response to an input corresponding to a request to re-layout the diagram, the processor may have automatically recursively carried out the previously described balancing process on each respective set of nodes added via each respective incremental expansion processes. In this example, the processor may do re-layout of the outgoing nodes 806 with respect to the root node 804, then do re-layout of all of the incoming nodes 808 with respect to the root node. Next, the processor may do the re-layout of the incoming nodes 810 that are relationally linked to the outgoing nodes, then do the re-layout of the outgoing nodes 812 that are relationally linked to the incoming nodes.

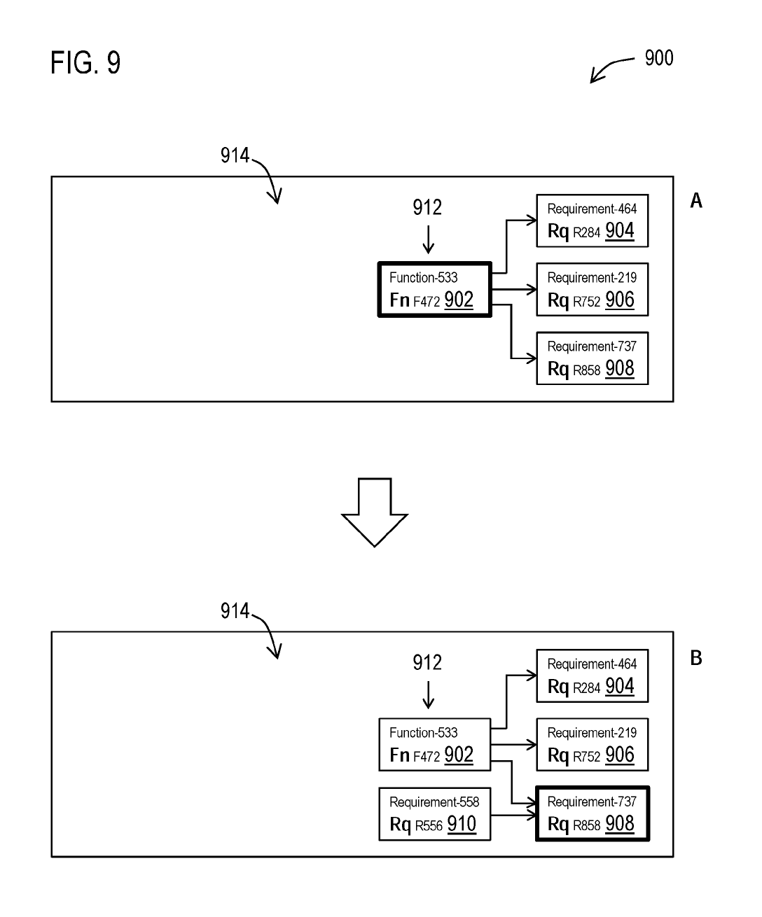

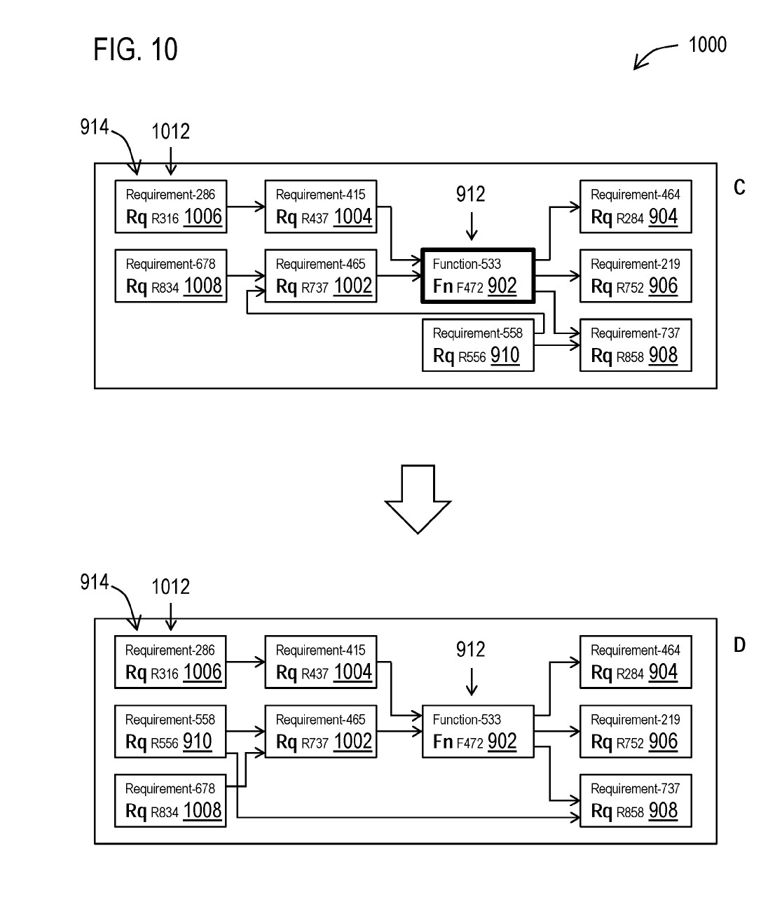

In example embodiments, some additional nodes may have circular relationships with respect to one or more pre-existing nodes. FIGS. 9 and 10 illustrate examples 900, 1000 of the incremental expansion process for such nodes of a diagram 914 in views A, B, and C and a balancing process to re-layout them in view D (where example 1000 follows the example 900).

In this example, the first selected node is the root node 902 that corresponds to the first node included in a diagram 914. As shown in view A of FIG. 9, the processor may be configured to enable a user to carry out a first incremental expansion processes to add one outgoing level with respect to the root node 902, which outgoing level includes a plurality of first additional nodes 904-908 that are outgoing nodes corresponding data objects that are children of the data object corresponding to the root node based on the parent-child relationships stored in the data store.

Also, as shown going from view A to B of FIG. 9, the processor may be configured to subsequently carry out a further incremental expansion process prior to the previously described second incremental expansions process in FIG. 1 in which incoming levels of nodes are added with respect to the root node 902. In this example, the processor may be configured to be responsive to a further input through the input device, carry out the further incremental expansion process to add to the diagram an incoming level with respect to a further selected node 908 that is one of the first additional nodes. This incoming level may include at least one further additional node 910 that is an incoming node corresponding to a data object that is a parent of the data object corresponding to the further selected node 908 based on the parent-child relationships stored in the data store. The diagraming algorithm may be configured to place this at least one further additional node 910 in the same column 912 as the root node. In this example, it should be noted that the further additional node 910 may correspond to a data object that is not a child of the data object for the root node 902. Rather as illustrated below in FIG. 10, the further additional node 910 could be an incoming node (e.g., a grandparent) to the root node 902 which forms a circular relationship.

Also, as shown going from view B of FIG. 9 to view C of FIG. 10, the processor may be configured to subsequently enable a user to provide another incremental expansion processes that adds one or more incoming levels with respect to the root node. This incoming level for the root node may include at least one second additional node 1002 that is an incoming node corresponding to a data object that is a parent of the data object corresponding to the root node 902 and corresponds to a data object that is also a child of the data object for the at least one further additional node 910. This at least one second additional node 1002 may be placed in a new column 1010.

It should be noted that even though the at least one further additional node 910 is a parent of the second additional node 1002, because it is a pre-existing node in the diagram it is not moved to the left of the second additional node 1002. Rather the diagraming algorithm maintains the further additional node 910 in the same column 912 as the root node 902 to the right of the second additional node 1002.

It should be appreciated that after these various nodes (including a circular relationship) have been displayed in the diagram, the user may wish to re-lay out the diagram in a manner that may be more cosmetically balanced. Thus, as shown going from view C to view D of FIG. 10, the processor may be configured to carry out a balancing process responsive to a received further input to re-layout the diagram. In this example, the processor may be configured to be responsive to a further input representative of a request to re-layout the diagram to re-position the at least one further additional node 910 in a column 1012 that does not include the root node 902. In view D of FIG. 10, the further additional node 910 is moved to the column 1012 that is to the left of the second additional node 1002.

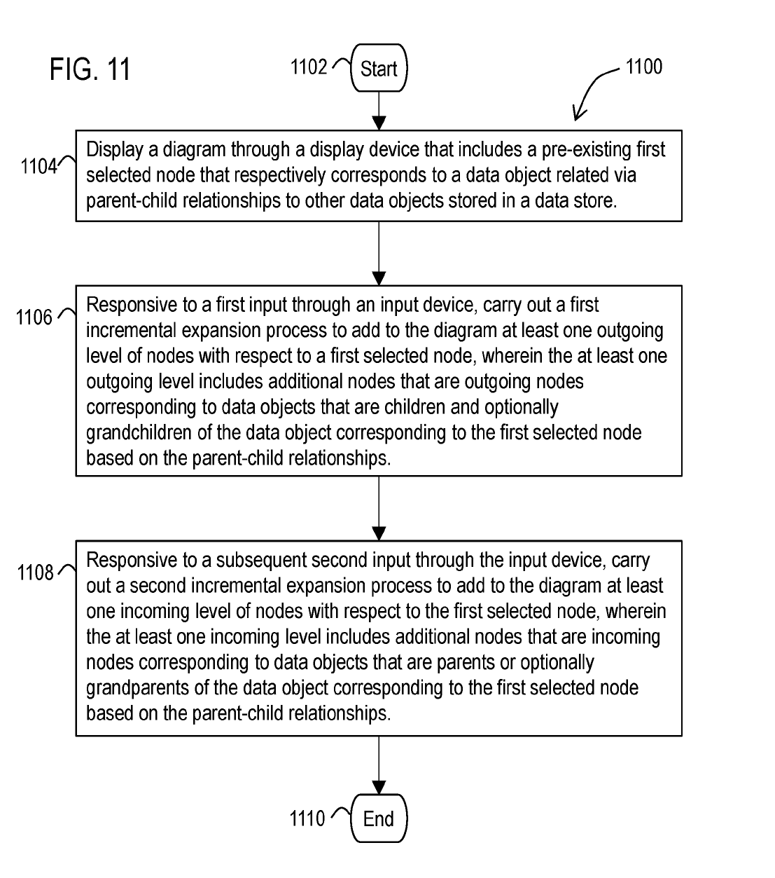

With reference now to FIG. 11, various example methodologies are illustrated and described. While the methodologies are described as being a series of acts that are performed in a sequence, it is to be understood that the methodologies may not be limited by the order of the sequence. For instance, some acts may occur in a different order than what is described herein. In addition, an act may occur concurrently with another act. Furthermore, in some instances, not all acts may be required to implement a methodology described herein.

It is important to note that while the disclosure includes a description in the context of a fully functional system and/or a series of acts, those skilled in the art will appreciate that at least portions of the mechanism of the present disclosure and/or described acts are capable of being distributed in the form of computer-executable instructions contained within non-transitory machine-usable, computer-usable, or computer-readable medium in any of a variety of forms, and that the present disclosure applies equally regardless of the particular type of instruction or data bearing medium or storage medium utilized to actually carry out the distribution. Examples of non-transitory machine usable/readable or computer usable/readable mediums include: ROMs, EPROMs, magnetic tape, hard disk drives, SSDs, flash memory, CDs, DVDs, and Blu-ray disks. The computer-executable instructions may include a routine, a sub-routine, programs, applications, modules, libraries, and/or the like. Still further, results of acts of the methodologies may be stored in a computer-readable medium, displayed on a display device, and/or the like.

Referring now to FIG. 11, a methodology 1100 is illustrated that facilitates incremental diagram node expansion. The methodology may start at 1102 and may include several acts carried out through operation of at least one processor. These acts may include an act 1104 of displaying a diagram through a display device that includes a pre-existing first selected node that respectively corresponds to a data object related via parent-child relationships to other data objects stored in a data store.

The methodology may also include an act 1106 of responsive to a first input through an input device, carrying out a first incremental expansion process to add to the diagram at least one outgoing level of nodes with respect to a first selected node. The at least one outgoing level may include additional nodes that are outgoing nodes corresponding to data objects that are children and optionally grandchildren of the data object corresponding to the first selected node based on the parent-child relationships.

In addition, the methodology may include an act 1108 of responsive to a subsequent second input through the input device, carrying out a second incremental expansion process to add to the diagram at least one incoming level of nodes with respect to the first selected node. The at least one incoming level may include additional nodes that are incoming nodes corresponding to data objects that are parents or optionally grandparents of the data object corresponding to the first selected node based on the parent-child relationships. At 1110 the methodology may end.

Also, it should be appreciated that this described methodology may include additional acts and/or alternative acts corresponding to the features described previously with respect to the data processing system 100.

For example, one or more incremental expansion processes may be carried out to cause a plurality of pre-existing nodes to be displayed in the diagram in a plurality of different columns corresponding to different hierarchical levels based on the parent-child relationships, with at least one column including more than one pre-existing node. With such a diagram, the methodology may further comprise an act of responsive to a further input through the input device, carrying out a further incremental expansion process with respect to a selected further node. Such a further incremental expansion process may include several acts includes determining at least one additional data object that is related via at least one parent-child relationship stored in the data store to the data object for the selected further node. In addition, the further incremental expansion process may include an act of determining a column for the diagram to add at least one additional node corresponding to the at least one additional data object based on the at least one parent-child relationship between the at least one additional data object and the data object for the selected further node, which determined column includes a plurality of pre-existing nodes. Also, the further incremental expansion process may include an act of determining a position in the determined column to display the at least one additional node such that the positions of all additional nodes added to the determined column are located adjacent all pre-existing nodes in the column and not between pre-existing nodes in the determined column and such that an alignment between the pre-existing nodes in different columns remains unchanged. In addition, the further incremental expansion process may include an act of causing the at least one addition node to be displayed in the diagram through the display device at the determined position in the determined column, such that the alignment between the pre-existing nodes in different columns remains unchanged.

The described methodology may also include an act of allocating each of the pre-existing nodes and each of the additional nodes to individual cells of a non-displayed two dimensional grid in which the cells are arrange in a plurality of columns and rows. Each cell may have a width and a height based on a respective width and a respective height of the respective column and respective row of each respective cell. Also, the cells may be larger in size than the nodes. In addition, the methodology may include relatively positioning the nodes in the diagram based on the relative positions of the cells in the grid.

It should also be appreciated that that the described/claimed columns of the grid may extend vertically with the rows of the grid extending horizontally on the display; or the described/claimed columns of the grid may extend horizontally with the rows of the grid extending vertically on the display. In other embodiments, the columns and rows may not be orientated exactly vertical or horizontal with respect to the display device or the direction of gravity, but may be orientated at other angles depending on the style of the diagram (e.g., the previously described grid 402 could be rotated 45 degrees in FIG. 4.

In addition, in another example, in response to a further input corresponding to a request to re-layout the diagram, the methodology may include automatically carrying out on the nodes in the diagram a balancing process that includes several acts including determining a largest column with the largest number of nodes relative to the number of nodes in at least one other column in the diagram. In addition, the balancing process may include an act of positioning the nodes in the determined largest column in cells such that there are no unfilled cells between the nodes in the largest column and at least one central node in the largest column is aligned with a root node in a further column, which root node corresponds to the first node included in the diagram. Further, the balancing process may include an act of positioning all nodes in the at least one other column in cells so as to be aligned with nodes in the largest column.

In a further example, when the diagram was generated via several incremental expansion processes to add a plurality of sets of both incoming and outgoing nodes, in response to the further input corresponding to a request to re-layout the diagram, the described methodology may include an act of automatically recursively carry out the balancing processes on each respective set of nodes added via each respective incremental expansion processes.

In addition, example embodiments of the methodology may include carry out incremental node expansion with respect to nodes having circular relationships. For example, the first selected node may be the root node that corresponds to the first node included in the diagram. The first incremental expansion process may include adding an outgoing level with respect to the root node, which outgoing level includes a plurality of first additional nodes that are outgoing nodes corresponding data objects that are children of the data object corresponding to the root node based on the parent-child relationships. Also, prior to carrying out the second incremental expansion process, the methodology may further comprise responsive to a further input through the input device, carrying out a further incremental expansion process to add to the diagram an incoming level with respect to a further selected node that is one of the first additional nodes. This incoming level may include at least one further additional node that is an incoming node corresponding to a data object that is a parent of the data object corresponding to the further selected node based on the parent-child relationships. The at least one further additional node may be placed in the same column as the root node and may correspond to a data object that is not a child of the data object for the root node. In this example, wherein the second incremental expansion process may include adding an incoming level with respect to the root node, which incoming level includes at least one second additional node that is an incoming node corresponding to a data object that is a parent of the data object corresponding to the root node. This at least one second additional node may be placed in a new column and may correspond to a data object that is also a child of the data object for the at least one further additional node.

In addition, the methodology may further comprise responsive to an input representative of a request to re-layout the diagram (with the recursive relationships), positioning the at least one further additional node in a column that does not include the root node.

As discussed previously, acts associated with these methodologies (other than any described manual acts) may be carried out by one or more processors. Such processor(s) may be included in one or more data processing systems, for example, that execute software components (including software instructions) operative to cause these acts to be carried out by the one or more processors. In an example embodiment, such software components may comprise computer-executable instructions corresponding to a routine, a sub-routine, programs, applications, modules, libraries, a thread of execution, and/or the like. Further, it should be appreciated that software components may be written in and/or produced by software code/environments/languages/frameworks such as machine code, assembly language, Java, JavaScript, Python, C, C#, C++ or any other software tool capable of producing software components and user interfaces configured to carry out the acts and features described herein.

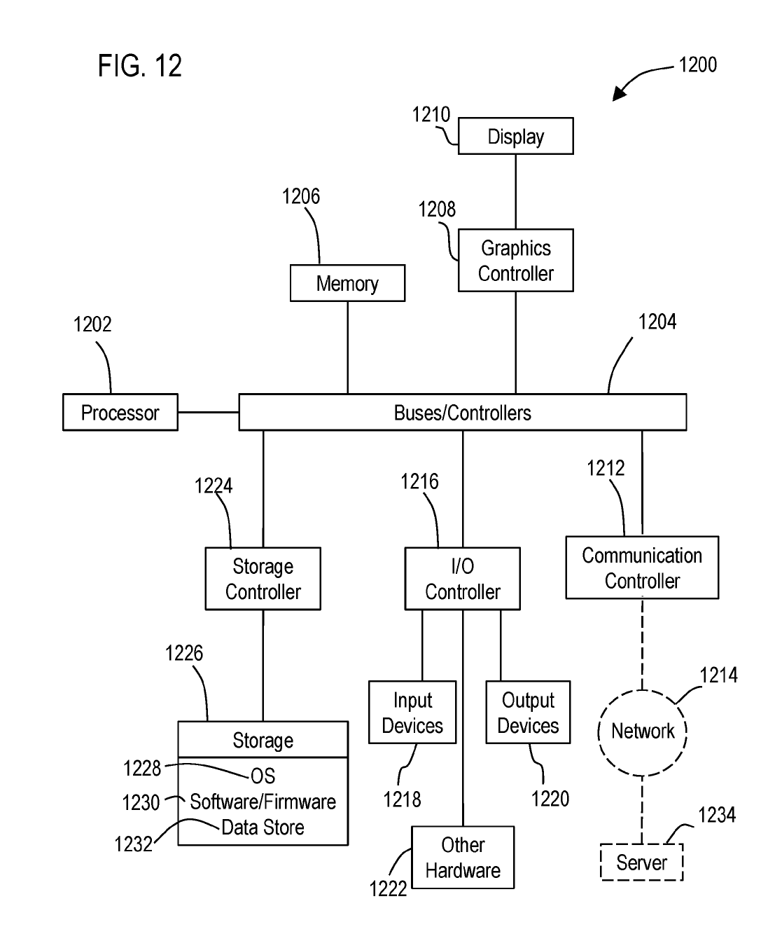

FIG. 12 illustrates a block diagram of a data processing system 1200 (e.g., a computer system) in which an embodiment can be implemented, for example, as a portion of a product system, and/or other system operatively configured by software or otherwise to perform the functions and processes as described herein. The data processing system depicted includes at least one processor 1202 (e.g., a CPU) that may be connected to one or more bridges/controllers/buses 1204 (e.g., a north bridge, a south bridge). One of the buses 1204, for example, may include one or more I/O buses such as a PCI Express bus. Also connected to various buses in the depicted example may include a main memory 1206 (RAM) and a graphics controller 1208. The graphics controller 1208 may be connected to one or more display devices 1210. It should also be noted that the processor 1202 may include a CPU cache memory. Further, in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 1212 (Ethernet controllers, WiFi controllers, cellular controllers) operative to connect to a local area network (LAN), Wide Area Network (WAN), a cellular network, and/or other wired or wireless networks 1214 or communication equipment.

Further components connected to various busses may include one or more I/O controllers 1216 such as USB controllers, Bluetooth controllers, and/or dedicated audio controllers (connected to speakers and/or microphones). It should also be appreciated that various peripherals may be connected to the I/O controller(s) (via various ports and connections) including input devices 1218 (e.g., keyboard, mouse, pointer, touch screen, touch pad, drawing tablet, trackball, buttons, keypad, game controller, gamepad, camera, microphone, scanners, motion sensing devices that capture motion gestures), output devices 1220 (e.g., printers, speakers) or any other type of device that is operative to provide inputs to or receive outputs from the data processing system.

Also, it should be appreciated that many devices referred to as input devices or output devices may both provide inputs and receive outputs of communications with the data processing system. For example, the processor 1202 may be integrated into a housing (such as a tablet) that includes a touch screen that serves as both an input and display device. Further, it should be appreciated that some input devices (such as a laptop) may include a plurality of different types of input devices (e.g., touch screen, touch pad, and keyboard). Also, it should be appreciated that other peripheral hardware 1222 connected to the I/O controllers 1216 may include any type of device, machine, or component that is configured to communicate with a data processing system.

Additional components connected to various busses may include one or more storage controllers 1224 (e.g., SATA). A storage controller may be connected to a storage device 1226 such as one or more storage drives and/or any associated removable media, which can be any suitable non-transitory machine usable or machine readable storage medium. Examples, include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also in some examples, a storage device such as an SSD may be connected directly to an I/O bus 1204 such as a PCI Express bus.

A data processing system in accordance with an embodiment of the present disclosure may include an operating system 1228, software/firmware 1230, and data stores 1232 (that may be stored on a storage device 1226 and/or the memory 1206). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data, which is retrievable by a processor.

The communication controllers 1212 may be connected to the network 1214 (which may or may not be a part of a data processing system 1200), which can be any local, wide area, remote, private, and/or public data processing system network or combination of networks, as known to those of skill in the art, including the Internet. Data processing system 1200 can communicate over the network 1214 with one or more other data processing systems such as a server 1234 (which may in combination correspond to a larger data processing system). For example, a larger data processing system may correspond to a plurality of smaller data processing systems implemented as part of a distributed system in which processors associated with several smaller data processing systems may be in communication by way of one or more network connections and may collectively perform tasks described as being performed by a single larger data processing system. Thus, it is to be understood that when referring to a data processing system, such a system may be implemented across several data processing systems organized in a distributed system in communication with each other via a network.

It should also be understood that the term “controller” means any device, system or part thereof that controls at least one operation, whether such a device is implemented in hardware, firmware, software or any combination thereof. It should be noted that the functionality associated with any particular controller may be centralized or distributed, whether locally or remotely. The described processor and memory may be included in a controller. Further, a controller may correspond to the described data processing system or any other hardware circuit that is operative to control at least one operation.

In addition, it should be appreciated that data processing systems may include virtual machines in a virtual machine architecture or cloud environment. For example, the processor 1202 and associated components may correspond to the combination of one or more virtual machine processors of a virtual machine operating in one or more physical processors of a physical data processing system. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 1200 in this example may correspond to a controller, computer, workstation, server, PC, notebook computer, tablet, mobile phone, and/or any other type of apparatus/system that is operative to process data and carry out functionality and features described herein associated with the operation of a data processing system, computer, processor, software components, and/or a controller discussed herein. The depicted example is provided for the purpose of explanation only and is not meant to imply architectural limitations with respect to the present disclosure.

Also, it should be noted that the processor described herein may correspond to a remote processor located in a data processing system such as a server that is remote from the display and input devices described herein. In such an example, the described display device and input device may be included in a client data processing system (which may have its own processor) that communicates with the server (which includes the remote processor) through a wired or wireless network (which may include the Internet). In some embodiments, such a client data processing system, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In another example, such a client data processing system may execute a web browser or thin client application. Inputs from the user may be transmitted from the web browser or thin client application to be evaluated on the server, rendered by the server, and an image (or series of images) sent back to the client data processing system to be displayed by the web browser or thin client application. Also in some examples, the remote processor described herein may correspond to a combination of a virtual processor of a virtual machine executing in a physical processor of the server.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device. Further the phrase “at least one” before an element (e.g., a processor) that is configured to carry out more than one function/process may correspond to one or more elements (e.g., processors) that each carry out the functions/processes and may also correspond to two or more of the elements (e.g., processors) that respectively carry out different ones of the one or more different functions/processes.

Also, at least one processor that is “configured to” carry out one or more functions or processes is defined herein as the combination of the at least one processor and the particular software/firmware instructions and/or wired circuits that when executed/operated by the at least one processor cause the at least one processor to carry out the one or more functions or processes described or recited herein. For example, a processor that is configured to carry out a particular function/process may correspond to the combination of the processor and the software/firmware instructions in which the processor is actively executing at least portions of the software/firmware instructions that are loaded into a volatile memory (e.g., RAM, CPU cache) and that are programmed to cause the processor to carry out the described or recited function/process. In addition, a processor that is configured to carry out a particular function/process may correspond to the combination of the processor and the software/firmware instructions in which the software/firmware instructions are stored in a non-volatile memory (e.g., flash memory, SSD, hard drive, or other storage device) in operative connection with the processor such that the software/firmware instructions are available to be accessed and executed by the processor to carry out the described function/process (even though none, or only portions of the software/firmware instructions are currently being executed by the processor).

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system 1200 may conform to any of the various current implementations and practices known in the art.

Also, it should be understood that the words or phrases used herein should be construed broadly, unless expressly limited in some examples. For example, the terms “include” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean: that an element is relatively near to but not in contact with a further element; or that the element is in contact with the further portion, unless the context clearly indicates otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A system for incremental diagram node expansion comprising:
at least one processor configured to:
display a diagram through a display device that includes a pre-existing first selected node that respectively corresponds to a data object related via parent-child relationships to other data objects stored in a data store;
responsive to a first input through an input device, carry out a first incremental expansion process to add at least one outgoing level of nodes to the diagram with respect to a first selected node, wherein the at least one outgoing level includes additional nodes that are outgoing nodes corresponding to data objects that are children and optionally grandchildren of the data object corresponding to the first selected node based on the parent-child relationships; and
responsive to a subsequent second input through the input device, carry out a second incremental expansion process to add to the diagram at least one incoming level of nodes with respect to the first selected node, wherein the at least one incoming level includes additional nodes that are incoming nodes corresponding to data objects that are parents or optionally grandparents of the data object corresponding to the first selected node based on the parent-child relationships.

2. The system according to claim 1, wherein the at least one processor is configured to:
allocate each of the pre-existing nodes and each of the additional nodes to individual cells of a of a non-displayed two dimensional grid in which the cells are arrange in a plurality of columns and rows, wherein each cell has a width and a height based on a respective width and a respective height of the respective column and respective row of each respective cell, wherein the cells are larger in size than the nodes; and
relatively position the nodes in the diagram based on the relative positions of the cells in the grid.

3. The system according to claim 2, wherein after at least one incremental expansion process has been carried out to cause a plurality of pre-existing nodes to be displayed in the diagram in a plurality of different columns corresponding to different hierarchical levels based on the parent-child relationships, with at least one column including more than one pre-existing node, the at least one processor is configured to:
responsive to a further input through the input device, carry out a further incremental expansion process with respect to a selected further node in which the at least one processor is configured to:
determine at least one additional data object that is related via at least one parent-child relationship stored in the data store to the data object for the selected further node;
determine a column for the diagram to add at least one additional node corresponding to the at least one additional data object based on the at least one parent-child relationship between the at least one additional data object and the data object for the selected further node, which determined column includes a plurality of pre-existing nodes;
determine a position in the determined column to display the at least one additional node such that the positions of all additional nodes added to the determined column are located adjacent all pre-existing nodes in the column and not between pre-existing nodes in the determined column and such that an alignment between the pre-existing nodes in different columns remains unchanged; and
cause the at least one addition node to be displayed in the diagram through the display device at the determined position in the determined column, such that the alignment between the pre-existing nodes in different columns remains unchanged.

4. The system according to claim 3, wherein columns of the grid extend vertically and rows of the grid extend horizontally on the display; or columns of the grid extend horizontally and rows of the grid extend vertically on the display.

5. The system according to claim 4, wherein the at least one processor is configured to:
in response to a further input corresponding to a request to re-layout the diagram, automatically carry out on the nodes in the diagram a balancing processes in which the at least one processor is configured to:
determine a largest column with the largest number of nodes relative to the number of nodes in at least one other column in the diagram;
position the nodes in the determined largest column in cells such that there are no unfilled cells between the nodes in the largest column and at least one central node in the largest column is aligned with a root node in a further column, which root node corresponds to the first node included in the diagram; and
position all nodes in the at least one other column in cells so as to be aligned with nodes in the largest column.

6. The system according to claim 5, wherein when the diagram was generated via several incremental expansion processes to add a plurality of sets of both incoming and outgoing nodes, in response to the further input corresponding to a request to re-layout the diagram, the processor is configured to automatically recursively carry out the balancing processes on each respective set of nodes added via each respective incremental expansion processes.

7. The system according to claim 2, wherein the first selected node is a root node that corresponds to the first node included in the diagram, wherein the first incremental expansion process includes adding an outgoing level with respect to the root node, which outgoing level includes a plurality of first additional nodes that are outgoing nodes corresponding data objects that are children of the data object corresponding to the root node based on the parent-child relationships,
wherein prior to carrying out the second incremental expansion process, the at least one processor is configured to: responsive to a further input through the input device, carry out a further incremental expansion process to add to the diagram an incoming level with respect to a further selected node that is one of the first additional nodes, which incoming level includes at least one further additional node that is an incoming node corresponding to a data object that is a parent of the data object corresponding to the further selected node based on the parent-child relationships, which at least one further additional node is placed in the same column as the root node and corresponds to a data object that is not a child of the data object for the root node,
wherein the second incremental expansion process includes adding an incoming level with respect to the root node, which incoming level includes at least one second additional node that is an incoming node corresponding to a data object that is a parent of the data object corresponding to the root node, which at least one second additional node is placed in a new column and corresponds to a data object that is also a child of the data object for the at least one further additional node,
wherein the at least one processor is configured to: responsive to a further input representative of a request to re-layout the diagram, position the at least one further additional node in a column that does not include the root node.

8. A method for incremental diagram node expansion comprising:
through operation of at least one processor:
displaying a diagram through a display device that includes a pre-existing first selected node that respectively corresponds to a data object related via parent-child relationships to other data objects stored in a data store;
responsive to a first input through an input device, carrying out a first incremental expansion process to add to the diagram at least one outgoing level of nodes with respect to a first selected node, wherein the at least one outgoing level includes additional nodes that are outgoing nodes corresponding to data objects that are children and optionally grandchildren of the data object corresponding to the first selected node based on the parent-child relationships; and
responsive to a subsequent second input through the input device, carrying out a second incremental expansion process to add to the diagram at least one incoming level of nodes with respect to the first selected node, wherein the at least one incoming level includes additional nodes that are incoming nodes corresponding to data objects that are parents or optionally grandparents of the data object corresponding to the first selected node based on the parent-child relationships.

9. The method according to claim 8, further comprising through operation of the at least one processor:
allocating each of the pre-existing nodes and each of the additional nodes to individual cells of a non-displayed two dimensional grid in which the cells are arrange in a plurality of columns and rows, wherein each cell has a width and a height based on a respective width and a respective height of the respective column and respective row of each respective cell, wherein the cells are larger in size than the nodes; and
relatively positioning the nodes in the diagram based on the relative positions of the cells in the grid.

10. The method according to claim 9, wherein after at least one incremental expansion process has been carried out to cause a plurality of pre-existing nodes to be displayed in the diagram in a plurality of different columns corresponding to different hierarchical levels based on the parent-child relationships, with at least one column including more than one pre-existing node, further comprising through operation of the at least one processor:
responsive to a further input through the input device, carrying out a further incremental expansion process with respect to a selected further node including:
determining at least one additional data object that is related via at least one parent-child relationship stored in the data store to the data object for the selected further node;
determining a column for the diagram to add at least one additional node corresponding to the at least one additional data object based on the at least one parent-child relationship between the at least one additional data object and the data object for the selected further node, which determined column includes a plurality of pre-existing nodes;
determining a position in the determined column to display the at least one additional node such that the positions of all additional nodes added to the determined column are located adjacent all pre-existing nodes in the column and not between pre-existing nodes in the determined column and such that an alignment between the pre-existing nodes in different columns remains unchanged; and
causing the at least one addition node to be displayed in the diagram through the display device at the determined position in the determined column, such that the alignment between the pre-existing nodes in different columns remains unchanged.

11. The method according to claim 10, wherein columns of the grid extend vertically and rows of the grid extend horizontally on the display; or columns of the grid extend horizontally and rows of the grid extend vertically on the display.

12. The method according to claim 11, further comprising through operation of the at least one processor:
in response to a further input corresponding to a request to re-layout the diagram, automatically carrying out on the nodes in the diagram a balancing process that includes:
determining a largest column with the largest number of nodes relative to the number of nodes in at least one other column in the diagram;
positioning the nodes in the determined largest column in cells such that there are no unfilled cells between the nodes in the largest column and at least one central node in the largest column is aligned with a root node in a further column, which root node corresponds to the first node included in the diagram; and
positioning all nodes in the at least one other column in cells so as to be aligned with nodes in the largest column.

13. The method according to claim 12, wherein when the diagram was generated via several incremental expansion processes to add a plurality of sets of both incoming and outgoing nodes, in response to the further input corresponding to a request to re-layout the diagram, through operation of the at least one processor:
automatically recursively carry out the balancing processes on each respective set of nodes added via each respective incremental expansion processes.

14. The method according to claim 9, wherein the first selected node is a root node that corresponds to the first node included in the diagram, wherein the first incremental expansion process includes adding an outgoing level with respect to the root node, which outgoing level includes a plurality of first additional nodes that are outgoing nodes corresponding data objects that are children of the data object corresponding to the root node based on the parent-child relationships,
wherein prior to carrying out the second incremental expansion process, further comprising responsive to a further input through the input device, carrying out a further incremental expansion process to add to the diagram an incoming level with respect to a further selected node that is one of the first additional nodes, which incoming level includes at least one further additional node that is an incoming node corresponding to a data object that is a parent of the data object corresponding to the further selected node based on the parent-child relationships, which at least one further additional node is placed in the same column as the root node and corresponds to a data object that is not a child of the data object for the root node,
wherein the second incremental expansion process includes adding an incoming level with respect to the root node, which incoming level includes at least one second additional node that is an incoming node corresponding to a data object that is a parent of the data object corresponding to the root node, which at least one second additional node is placed in a new column and corresponds to a data object that is also a child of the data object for the at least one further additional node,
further comprising through operation of the at least one processor responsive to an input representative of a request to re-layout the diagram, positioning the at least one further additional node in a column that does not include the root node.

15. A non-transitory computer readable medium encoded with executable instructions that when executed, cause at least one processor to carry out a method for incremental diagram node expansion comprising:
displaying a diagram through a display device that includes a pre-existing first selected node that respectively corresponds to a data object related via parent-child relationships to other data objects stored in a data store;
responsive to a first input through an input device, carrying out a first incremental expansion process to add to the diagram at least one outgoing level of nodes with respect to a first selected node, wherein the at least one outgoing level includes additional nodes that are outgoing nodes corresponding to data objects that are children and optionally grandchildren of the data object corresponding to the first selected node based on the parent-child relationships; and
responsive to a subsequent second input through the input device, carrying out a second incremental expansion process to add to the diagram at least one incoming level of nodes with respect to the first selected node, wherein the at least one incoming level includes additional nodes that are incoming nodes corresponding to data objects that are parents or optionally grandparents of the data object corresponding to the first selected node based on the parent-child relationships.

16. The computer readable medium according to claim 15, the method further comprising:
allocating each of the pre-existing nodes and each of the additional nodes to individual cells of a non-displayed two dimensional grid in which the cells are arrange in a plurality of columns and rows, wherein each cell has a width and a height based on a respective width and a respective height of the respective column and respective row of each respective cell, wherein the cells are larger in size than the nodes; and
relatively positioning the nodes in the diagram based on the relative positions of the cells in the grid.

17. The computer readable medium according to claim 16, wherein after at least one incremental expansion process has been carried out to cause a plurality of pre-existing nodes to be displayed in the diagram in a plurality of different columns corresponding to different hierarchical levels based on the parent-child relationships, with at least one column including more than one pre-existing node, the method further comprising:
responsive to a further input through the input device, carrying out a further incremental expansion process with respect to a selected further node including:
determining at least one additional data object that is related via at least one parent-child relationship stored in the data store to the data object for the selected further node;
determining a column for the diagram to add at least one additional node corresponding to the at least one additional data object based on the at least one parent-child relationship between the at least one additional data object and the data object for the selected further node, which determined column includes a plurality of pre-existing nodes;
determining a position in the determined column to display the at least one additional node such that the positions of all additional nodes added to the determined column are located adjacent all pre-existing nodes in the column and not between pre-existing nodes in the determined column and such that an alignment between the pre-existing nodes in different columns remains unchanged; and
causing the at least one addition node to be displayed in the diagram through the display device at the determined position in the determined column, such that the alignment between the pre-existing nodes in different columns remains unchanged.

18. The computer readable medium according to claim 17, wherein columns of the grid extend vertically and rows of the grid extend horizontally on the display; or columns of the grid extend horizontally and rows of the grid extend vertically on the display.

19. The computer readable medium according to claim 18, the method further comprising:
in response to a further input corresponding to a request to re-layout the diagram, automatically carrying out on the nodes in the diagram a balancing process that includes:
determining a largest column with the largest number of nodes relative to the number of nodes in at least one other column in the diagram;
positioning the nodes in the determined largest column in cells such that there are no unfilled cells between the nodes in the largest column and at least one central node in the largest column is aligned with a root node in a further column, which root node corresponds to the first node included in the diagram; and
positioning all nodes in the at least one other column in cells so as to be aligned with nodes in the largest column.

20. The computer readable medium according to claim 19, wherein when the diagram was generated via several incremental expansion processes to add a plurality of sets of both incoming and outgoing nodes, in response to the further input corresponding to a request to re-layout the diagram, the method further comprising:
automatically recursively carry out the balancing processes on each respective set of nodes added via each respective incremental expansion processes.
